(19) United States
(12) Patent Application Publication
(10) Pub. No.: US 2024/0417556 A1
(43) Pub. Date: Dec. 19, 2024

(54) THERMOPLASTIC COMPOSITIONS

(71) Applicant: Dow Global Technologies LLC, Midland, MI (US)

(72) Inventors: Yongchao Zeng, Houston, TX (US); Andrew T. Heitsch, Angleton, TX (US); Bo Liu, Pearland, TX (US); Mridula Kapur, Lake Jackson, TX (US)

(73) Assignee: Dow Global Technologies LLC, Midland, MI (US)

(21) Appl. No.: 18/699,980

(22) PCT Filed: Oct. 10, 2022
(86) PCT No.: PCT/US2022/046159

§ 371 Date: Apr. 10, 2024

Related U.S. Application Data
(60) Provisional application No. 63/256,225, filed on Oct. 15, 2021.

(51) Int. Cl. C08L 23/26; C08L 23/06

(52) U.S. Cl. CPC C08L 23/26; C08L 23/06; C08L 2205/025; C08L 2207/20; C08L 2314/06

(57) ABSTRACT

Embodiments are directed towards thermoplastic compositions comprising: a virgin raw polymer, wherein the virgin raw polymer comprises a hydrogenation-catalyst treated polyethylene and a recycled polyethylene wherein the recycled polyethylene comprises either a first blend of polyethylenes recovered from post-consumer material, a second blend of polyethylenes recovered from pre-consumer material, or a combination of the first and second blends.

### FIELD OF DISCLOSURE

Embodiments of the present disclosure are directed towards thermoplastic compositions, more specifically, thermoplastic compositions comprising a virgin raw polymer and a recycled polyethylene.

### BACKGROUND

Different polymers are made utilizing various polymerization processes and/or different reaction components. For instance, different polymers are made utilizing solution, slurry, or gas phase polymerization processes. The various polymerization processes may utilize different catalysts, for example, Ziegler-Natta catalysts, chromium-based catalysts, metallocene catalysts, or combinations thereof. The different polymerization processes and different reaction components are utilized to make polymers having varying properties. There exists a continuing need for new thermoplastic compositions.

### SUMMARY

The present disclosure provides thermoplastic compositions comprising: a virgin raw polymer, wherein the virgin raw polymer comprises a hydrogenation-catalyst treated polyethylene, and the virgin raw polymer has a melt index (I₂) from 0.1 to 1.0 dg/min, a density from 0.850 to 0.940 g/cm³, a melt index (I₂₁) from 0.1 to 50 dg/min, a melt index (I₂₁/12) ratio less than or equal to 18.5, a Mw (Abs)/Mn (Abs) from 2.0 to 3.5, a Mz (Abs)/Mw (Abs) from 1.7 to 4.5, and a cumulative detector fraction (CDF_{Ls}) at a molecular weight of >1,000,000 g/mol of greater than 100*(0.0536-121*0.00224) %; and a recycled polyethylene wherein the recycled polyethylene comprises either a first blend of polyethylenes recovered from post-consumer material, a second blend of polyethylenes recovered from pre-consumer material, or a combination of the first and second blends; and wherein the recycled polyethylene has: a density of from 0.900 g/cm³ to 0.940 g/cm³ when measured according to ASTM D792-08, Method B; a melt index (I₂) of from 0.30 dg/min to 6.00 dg/min when measured according to ASTM D1238-10, Method B, at 190° C. and a 2.16 kg load, wherein the virgin raw polymer is from 80 wt % to 25 wt % of the thermoplastic composition based upon a total weight of the virgin raw polymer and the recycled polyethylene, and the recycled polyethylene is from 20 to 75 wt % of the thermoplastic composition based upon the total weight of the virgin raw polymer and the recycled polyethylene.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

Thermoplastic compositions comprising a virgin raw polymer and a recycled polyethylene are disclosed herein.

The term “virgin raw polymer” refers to polymers that can be characterized as “primary (virgin) raw material,” as defined by ISO 18604. The term virgin raw polymer thus includes polymers that have never been processed into any form of end-use product. Virgin raw polymer may also be referred to as “primary raw polymer”, among other terms. Virgin raw polymers are discussed further herein.

The term “recycled polyethylene” refers to polymers, e.g., polyethylenes, recovered from post-consumer material as defined by ISO 14021, polymers recovered from pre-consumer material as defined by ISO 14021, and combinations thereof. Recycled polyethylenes are discussed further herein.

Advantageously the thermoplastic compositions disclosed herein provide select processability parameters, e.g. a combination of properties, that are desirable for a number of applications. For example, the thermoplastic compositions disclosed herein can have a complex viscosity at 100 rad/s (190° C.) from 2500 to 3900 Pas, while also having a melt strength (190° C.) from 7 to 15 cN. The select processability parameters can help provide improved extruder back pressures as well as improved bubble stability, among other benefits.

Embodiments of the present disclosure provide that the virgin raw polymer comprises a hydrogenation-catalyst treated polyethylene, e.g., an ethylene/1-hexene copolymer. As used herein a “hydrogenation-catalyst treated polyethylene” is made with a zirconocene catalyst and a hydrogenation catalyst. The hydrogenation-catalyst treated polyethylene can be made utilizing a gas-phase reactor system. One or more embodiments provide that two polymerization reactors, e.g., arranged in-series, may be utilized. One or more embodiments provide that a single polymerization reactor is utilized. For instance, the hydrogenation-catalyst treated polyethylene can be made utilizing a fluidized bed reactor. Gas-phase reactors are known and known components may be utilized for the fluidized bed reactor.

A copolymer is made from olefins, e.g., ethylene and 1-hexene. For example, when a copolymer is said to have an ethylene content of 75 wt % to 95 wt %, it is understood that the polymer unit in the copolymer is derived from ethylene in the polymerization reaction(s) and the derived units are present at 75 wt % to 95 wt %, based upon the total weight of the polymer.

Examples of hydrogenation-catalyst treated polyethylenes, e.g., ethylene/1-hexene copolymers, include ethylene-based polymers, having at least 50 wt % ethylene. One or more embodiments provide that the hydrogenation-catalyst treated polyethylenes can include from 50 to 99.9 wt % of units derived from ethylene based on a total weight of the polyethylene. All individual values and subranges from 50 to 99.9 wt % are included; for example, the polyethylene can include from a lower limit of 50, 60, 70, 80, or 90 wt % of units derived from ethylene to an upper limit of 99.9, 99.7, 99.4, 99, 96, 93, 90, or 85 wt % of units derived from ethylene based on the total weight of the polyethylene. The polyethylene can include from 0.1 to 50 wt % of units derived from comonomer, e.g., 1-hexene, 1-butene, or 1-octene, based on the total weight of the polyethylene. One or more embodiments provide that ethylene is utilized as a monomer and 1-hexene is utilized as a comonomer. One or more embodiments provide that ethylene is utilized as a monomer and 1-butene is utilized as a comonomer. One or more embodiments provide that ethylene is utilized as a monomer and 1-octene is utilized as a comonomer. One or more embodiments provide that the copolymer is an ethylene/1-hexene copolymer, an ethylene/1-butene copolymer, an ethylene/1-octene copolymer, or a combination thereof.

As mentioned, the hydrogenation-catalyst treated polyethylene can be made in a fluidized bed reactor. The fluidized bed reactor can have a reaction temperature from 70 to 95° C. All individual values and subranges from 70 to 95° C. are included; for example, the first fluidized bed reactor can have a reaction temperature from a lower limit of 70, 73, or 75° C. to an upper limit of 95, 90, or 88° C.

The fluidized bed reactor can have an ethylene partial pressure from 125 to 275 pounds per square inch (psi). All individual values and subranges from 125 to 275 are included; for example, the fluidized bed reactor can have an ethylene partial pressure from a lower limit of 125, 150, or 175 psi to an upper limit of 275, 250, or 225 psi.

One or more embodiments provide that ethylene is utilized as a monomer and 1-hexene is utilized as a comonomer for making the hydrogenation-catalyst treated polyethylene. The fluidized bed reactor can have a comonomer to ethylene mole ratio, e.g., C6/C2, from 0.002 to 0.100. All individual values and subranges from 0.002 to 0.100 are included; for example, the fluidized bed reactor can have a comonomer to ethylene mole ratio from a lower limit of 0.002, 0.003, or 0.004 to an upper limit of 0.100, 0.050, or 0.030.

The fluidized bed reactor can have a hydrogen to ethylene mole ratio (H2/C2) from 0.00001 to 0.00100. All individual values and subranges from 0.00001 to 0.00100 are included; for example, the fluidized bed reactor can have a H2/C2 from a lower limit of 0.00001, 0.00005, or 0.00008 to an upper limit of 0.00100, 0.00070, or 0. 0.00050. One or more embodiments provide that a hydrogen feed to the fluidized bed reactor is not utilized; however, hydrogen may be generated in situ under polymerizable conditions for making the polyolefin compositions disclosed herein.

The fluidized bed reactor can have an isopentane mole percent from 1.0 to 15.0 percent. All individual values and subranges from 1.0 to 15.0 percent are included; for example, the fluidized bed reactor can have an isopentane mole percent from a lower limit of 1.0, 1.5, 2.0, or 2.5 percent to an upper limit of 15.0, 13.0, 10.0, or 7.0 percent.

The hydrogenation-catalyst treated polyethylene can have a density from 0.850 to 0.940 g/cm³. Density can be determined by according to ASTM D792-08. Method B. All individual values and subranges from 0.850 to 0.940 g/cm³ are included; for example, the hydrogenation-catalyst treated polyethylene can have a density from a lower limit of 0.850, 0.870, 0.900, 0.902, 0.904, 0.906, or 0.908, g/cm³ to an upper limit of 0.940, 0.935, 0.930, 0.925, 0.923, or 0.920 g/cm³. One or more embodiments provide that the hydrogenation-catalyst treated polyethylene has a density from 0.850 to 0.935 g/cm³, or from 0.870 to 0.930 g/cm³.

The hydrogenation-catalyst treated polyethylene can have a melt index (I₂) from 0.1 to 1.0 dg/min. 12 can be determined by according to ASTM D1238-10 (190° C., 2.16 kg). All individual values and subranges from 0.1 to 1.0 dg/min are included; for example, the hydrogenation-catalyst treated polyethylene can have an 12 from a lower limit of 0.10, 0.12, 0.13, 0.14, or, 0.15, dg/min to an upper limit of 1.0, 0.75, 0.5, 0.45, 0.40, 0.35, 0.30, 0.25 or 0.20 dg/min.

The hydrogenation-catalyst treated polyethylene can have a melt index (15) from 0.1 to 3.0 dg/min. 15 can be determined according to ASTM D1238-10 (190° C., 5 kg). All individual values and subranges from 0.1 to 3.0 dg/min are included; for example, the hydrogenation-catalyst treated polyethylene can have an 15 from a lower limit of 0.1, 0.2, 0.3, or 0.4 dg/min to an upper limit of 3.0, 2.5, 2.0, 1.5, or 1.0 dg/min.

The hydrogenation-catalyst treated polyethylene can have a melt index (I₂₁) from 1.0 to 20 dg/min. 121 can be determined according to ASTM D1238-10 (190° C., 21.6 kg). All individual values and subranges from 1.0 to 20 dg/min are included; for example, the hydrogenation-catalyst treated polyethylene can have an I₂₁ from a lower limit of 1.0, 1.5, 2.0, or 2.5 dg/min to an upper limit of 20, 18, 15, 10, 7, 5, or 3 dg/min.

The hydrogenation-catalyst treated polyethylene can have an I₂₁ to 12 ratio (I₂₁/12) less than or equal to 18.5. For instance, the hydrogenation-catalyst treated polyethylene can have an I₂₁/12 from a lower limit 8.0, 10.0, 13.0, or 15.0 to an upper limit of 18.5, 18.0, 17.7, or 17.5.

The hydrogenation-catalyst treated polyethylene can have an I₂₁ to 15 ratio (121/15) from 3 to 10. All individual values and subranges from 3 to 10 are included; for example, the hydrogenation-catalyst treated polyethylene composition can have an I_{21/15} from a lower limit of 3, 4, or 5.5 to an upper limit of 10, 8, or 7.5.

The hydrogenation-catalyst treated polyethylene can have a weight average molecular weight (Mw (Abs)) from 65,000 to 250,000 g/mol. All individual values and subranges from 65,000 to 250,000 g/mol are included; for example, the hydrogenation-catalyst treated polyethylene can have an Mw (Abs) from a lower limit of 65,000, 85,000, or 100,000 g/mol to an upper limit of 250,000, 225,000, or 200,000 g/mol. Mw (Abs) can be determined by conventional gel permeation chromatography (GPC), as is known in the art. Absolute GPC is discussed herein. Alternatively, the hydrogenation-catalyst treated polyethylene can have a weight average molecular weight (M_{w} (Conv)) from 65,000 to 250,000 g/mol. All individual values and subranges from 65,000 to 250,000 g/mol are included; for example, the hydrogenation-catalyst treated polyethylene can have an M_{w} (Conv) from a lower limit of 65,000, 85,000, or 100,000 g/mol to an upper limit of 250,000, 225,000, or 200,000 g/mol. M_{w} (Conv) can be determined by conventional gel permeation chromatography (GPC), as is known in the art. Conventional GPC is discussed herein.

The hydrogenation-catalyst treated polyethylene can have a number average molecular weight (Mn (Abs)) from 20,000 to 85,000 g/mol. All individual values and subranges from 20,000 to 85,000 g/mol are included; for example, the hydrogenation-catalyst treated polyethylene can have an Mn from a lower limit of 20,000, 25,000, or 30,000 g/mol to an upper limit of 85,000, 80,000, or 70,000 g/mol. Mn (Abs) can be determined by absolute gel permeation chromatography (GPC), as is known in the art. Absolute GPC is discussed herein. Alternatively, the hydrogenation-catalyst treated polyethylene can have a number average molecular weight (Mn(Conv)) from 20,000 to 85,000 g/mol. All individual values and subranges from 20,000 to 85,000 g/mol are included; for example, the hydrogenation-catalyst treated polyethylene can have an Mn(Conv) from a lower limit of 20,000, 25,000, or 30,000 g/mol to an upper limit of 85,000, 80,000, or 70,000 g/mol. Mn(Conv) can be determined by conventional gel permeation chromatography (GPC), as is known in the art. Conventional GPC is discussed herein.

The hydrogenation-catalyst treated polyethylene can have a Z-average molecular weight (Mz (Abs)) from 250,000 to 800,000 g/mol. All individual values and subranges from 250,000 to 800,000 g/mol are included; for example, the ethylene/1-hexene copolymer can have an Mz (Abs) from a lower limit of 250,000, 260,000, or 275,000 g/mol to an upper limit of 800,000, 700,000, or 650,000 g/mol. Mz (Abs) can be determined by absolute gel permeation chromatography (GPC), as is known in the art. Absolute GPC is discussed herein. Alternatively, the hydrogenation-catalyst treated polyethylene can have a Z-average molecular weight (M₂ (Conv)) from 250,000 to 800,000 g/mol. All individual values and subranges from 250,000 to 800,000 g/mol are included; for example, the ethylene/1-hexene copolymer can have an M₂ (Conv) from a lower limit of 250,000, 260,000, or 275,000 g/mol to an upper limit of 800,000, 700,000, or 650,000 g/mol. M₂ (Conv) can be determined by conventional gel permeation chromatography (GPC), as is known in the art. Conventional GPC is discussed herein

The hydrogenation-catalyst treated polyethylene can have a weight average molecular weight to number average molecular weight ratio (M_{w} (Abs)/Mn (Abs)) from 2.0 to 3.5. All individual values and subranges from 2.0 to 3.5 are included; for example, the hydrogenation-catalyst treated polyethylene can have an M_{w} (Abs)/Mn (Abs) from a lower limit of 2.0, 2.1, 2.2, 2.3, 2.4, 2.5, or 2.6, or to an upper limit of 3.5, 3.4, 3.3, 3.2, 3.1, or 3.0. Alternatively, the hydrogenation-catalyst treated polyethylene can have a weight average molecular weight to number average molecular weight ratio (M_{w} (Conv)/Mn(Conv) from 2.0 to 3.5. All individual values and subranges from 2.0 to 3.5 are included; for example, the hydrogenation-catalyst treated polyethylene can have an M_{w} (Conv)/Mn(Conv) from a lower limit of 2.0, 2.1, 2.2, 2.3, 2.4, 2.5, or 2.6, or to an upper limit of 3.5, 3.4, 3.3, 3.2, 3.1, or 3.0.

The hydrogenation-catalyst treated polyethylene can have a Z-average molecular weight to weight average molecular weight ratio (Mz (Abs)/M_{w} (Abs)) from 1.7 to 4.5. All individual values and subranges from 1.7 to 4.5 are included; for example, the hydrogenation-catalyst treated polyolefin can have an Mz (Abs)/M_{w} (Abs) from a lower limit of 1.7 to an upper limit of 4.5, 4.0, or 3.7. Alternatively, the hydrogenation-catalyst treated polyethylene can have a Z-average molecular weight to weight average molecular weight ratio (Mz (Conv)/M_{w} (Conv)) from 1.7 to 4.5. All individual values and subranges from 1.0 to 4.5 are included; for example, the hydrogenation-catalyst treated polyolefin can have an Mz (Conv)/M_{w} (Conv) from a lower limit of 1.7 to an upper limit of 4.5, 4.0, or 3.7.

As mentioned, the hydrogenation-catalyst treated polyethylenes are made with a zirconocene catalyst and a hydrogenation catalyst.

Zirconocene catalysts are metallocenes that include zirconium. Metallocenes, e.g., zirconocenes, are known in the art. For instance, metallocene catalyst compounds include “half sandwich” and/or “full sandwich” compounds having one or more Cp ligands (cyclopentadienyl and ligands isolobal to cyclopentadienyl) bound to at least one Group 3 to Group 12 metal atom, and one or more leaving group(s) bound to the at least one metal atom. As used herein, all reference to the Periodic Table of the Elements and groups thereof is to the NEW NOTATION published in HAWLEY'S CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted. The Cp ligands are one or more rings or ring system(s), at least a portion of which includes TT-bonded systems, such as cycloalkadienyl ligands and heterocyclic analogues. Embodiments of the present disclosure provide that the zirconocene catalyst can be made by a number of processes, e.g. with conventional solvents, reaction conditions, reaction times, and isolation procedures, utilized for making known metallocenes. Embodiments of the present disclosure provide that the zirconocene catalyst can be obtained commercially. For instance, one or more embodiments provide that the zirconocene catalyst is XCAT™ HP-100, available from Univation Technologies, LLC.

While not wishing to be bound to theory, hydrogenation catalysts may reduce the concentration of molecular hydrogen, which may be referred to as hydrogen herein, in a reaction system. Hydrogen can be intentionally added to a reaction system or generated by a metallocene catalyst during a polymerization process. Embodiments of the present disclosure provide that a titanocene catalyst may be utilized as the hydrogenation catalyst. Titanocene catalysts are metallocenes that include titanium.

Titanocene are catalysts are known in the art. Embodiments of the present disclosure provide that the titanocene catalyst can be made by a number of processes, e.g., with conventional solvents, reaction conditions, reaction times, and isolation procedures, utilized for making known metallocenes. Embodiments of the present disclosure provide that the titanocene catalyst system can be obtained commercially. Embodiments of the present disclosure provide that the titanocene catalyst system can be obtained through the combination of commercially available materials, for instance.

As is known in the art, an activator may be utilized. As used herein, “activator” refers to any compound or combination of compounds, supported, or unsupported, which can activate a complex or a catalyst component, such as by creating a cationic species of the catalyst component, e.g., to provide the catalyst. The activator may also be referred to as a “co-catalyst”. The activator can include a Lewis acid or a non-coordinating ionic activator or ionizing activator, or any other compound including Lewis bases, aluminum alkyls, and/or conventional-type co-catalysts. Activating conditions are well known in the art.

Embodiments provide that the titanium to zirconium molar ratio utilized may be from 0.100 to 0.700. All individual values and subranges from 0.100 to 0.700 are included; for example, the titanium to zirconium molar ratio can be from a lower limit of 0.100, 0.150, or 0.200 to an upper limit of 0.700, 0.600, or 0.500.

The hydrogenation-catalyst treated polyethylene can have a cumulative detector fraction (CDF_{Ls}) at a molecular weight (MW) of ≥1,000,000 g/mol of greater than 100*(0.0536-I₂₁*0.00224). This CDF_{Ls} may indicate the high molecular species of the polyolefin composition at given melt flow rate (21). CDF_{Ls} can be determined via Low-Angle Laser Light Scattering (LALLS). CDF_{Ls} can be determined as follows.

Gel permeation chromatography (GPC) Test Method for measuring molecular weights using a concentration-based detector (conventional GPC or “GPC_{conv}”): Use a PolymerChar GPC-IR (Valencia, Spain) high temperature GPC chromatograph equipped with an internal IR5 infra-red detector (IR5, measurement channel). Set temperatures of the autosampler oven compartment at 160° C. and column compartment at 150° C. Use a column set of four Agilent “Mixed A” 30 cm 20-micron linear mixed-bed columns; solvent is 1,2,4 trichlorobenzene (TCB) that contains 200 ppm of butylated hydroxytoluene (BHT) sparged with nitrogen. Injection volume is 200 microliters. Set flow rate to 1.0 milliliter/minute. Calibrate the column set with 21 narrow molecular weight distribution polystyrene (PS) standards (Agilent Technologies) with molecular weights ranging from 580 to 8,400,000. The PS standards were arranged in six “cocktail” mixtures with approximately a decade of separation between individual molecular weights in each vial. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. Convert the PS standard peak molecular weights (“MPS”) to polyethylene molecular weights (“MPE”) using the method described in Williams and Ward, J. Polym. Sci., Polym. Let., 6, 621 (1968) and equation 1: (M_{polyethylene}=A×(M_{polystyrene})^{B} (EQ1), wherein M_{polyethylene} is molecular weight of polyethylene, M_{polystyrene} is molecular weight of polystyrene, A=0.4315, x indicates multiplication, and B=1.0. Dissolve samples at 2 mg/mL in TCB solvent at 160° C. for 2 hours under low-speed shaking. Generate a baseline-subtracted infra-red (IR) chromatogram at each equally-spaced data collection point (i), and obtain polyethylene equivalent molecular weight from a narrow standard calibration curve for each point (i) from EQ1.

The total plate count of the GPC column set was performed with decane without further dilution. The plate count (Equation 2) and symmetry (Equation 3) were measured on a 200 microliter injection according to the following equations.

$$Plate Count = 5.54 * {( \frac{( {RV}_{Peak Max}}{Peak Width at \frac{1}{2} height} )}^{2} . \qquad ( EQ2 )$$

where RV is the retention volume in milliliters, the peak width is in milliliters, the peak max is the maximum height of the peak, and ½ height is ½ height of the peak maximum.

$$Symmetry = \frac{( Rear Peak {RV}_{one tenth height} - {RV}_{Peak max} )}{( {RV}_{Peak max} - Front Peak {RV}_{one tenth height} )} . \qquad Equation 3$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Calculate number-average molecular weight (referred to as Mn (GPC) or Mn(Conv)), weight-average molecular weight (referred to as M_{w(GPC)} or M_{w} (Conv)) and z-average molecular weight (referred to as M_{z(GPC)} or M_{z} (Conv)) based on GPC results using the internal IR5 detector (measurement channel) with PolymerChar GPCOne™ software and equations 4 to 6, respectively, the baseline-subtracted IR chromatogram at each equally-spaced data collection point (i), and the polyethylene equivalent molecular weight obtained from the narrow standard calibration curve for the point (i) from Equation 1.

$$Equation 4 :$$

$${Mn}_{( GPC )} = \frac{{\sum }^{i} {IR}_{i}}{{\sum }^{i} ( {IR}_{i} / {M}_{{polyethylene}_{i}} )} . \qquad ( EQ4 )$$

$$Equation 5 :$$

$${Mw}_{( GPC )} = \frac{{\sum }^{i} ( {IR}_{i} * {M}_{{polyethylene}_{i}} )}{{\sum }^{i} {IR}_{i}} . \qquad ( EQ5 )$$

$$Equation 6 :$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} . \qquad ( EQ6 )$$

Monitor effective flow rate over time using decane as a nominal flow rate marker during sample runs. Look for deviations from the nominal decane flow rate obtained during narrow standards calibration runs. If necessary, adjust the effective flow rate of decane so as to stay within ±2%, alternatively ±1%, of the nominal flow rate of decane as calculated according to equation 7: Flow rate (effective)=Flow rate (nominal)*(RV(FM Calculated)/RV(FM Sample) (EQ7), wherein Flow rate (effective) is the effective flow rate of decane, Flowrate (nominal) is the nominal flow rate of decane, RV(FM Calibrated) is retention volume of flow rate marker decane calculated for column calibration run using narrow standards, RV(FM Sample) is retention volume of flow rate marker decane calculated from sample run,*indicates mathematical multiplication, and/indicates mathematical division. Discard any molecular weight data from a sample run with a decane flow rate deviation more than +2%, alternatively ±1%.

Gel Permeation Chromatography Test Method for measuring absolute molecular weight measurements (absolute GPC or “GPC_{abs}”) using the PolymerChar GPC-IR high temperature GPC chromatograph equipped with the internal IR5 infra-red detector (IR5), wherein the IR5 detector is coupled to a Precision Detectors (Now Agilent Technologies) 2-angle laser light scattering (LS) detector Model 2040. For all Light scattering measurements, the 15 degree angle is used for measurement purposes.

For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chapter 12, (1992)) (Balke, Thitiratsakul, Lew, Cheung, Mourey, Chromatography Polym. Chapter 13, (1992)), optimizing triple detector log (MW and IV) results from a broad homopolymer polyethylene standard (Mw/Mn>3) to the narrow standard column calibration results from the narrow standards calibration curve using PolymerChar GPCOne™ Software.

The absolute molecular weight data are obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of 0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

Absolute weight-average molecular weight (MW (Abs)) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™).

Absolute number-average molecular weight (Mn_{(Abs)}) and absolute z-average molecular weight (MZ (Abs) are calculated according to equations 8-9 as follows:

$${Mn}_{( Abs )} = \frac{{\sum }^{i} {IR}_{i}}{{\sum }^{i} ( {IR}_{i} / {M}_{{Absolute}_{i}} )} . \qquad ( EQ 8 )$$

$${Mz}_{( Abs )} = \frac{{\sum }^{i} ( {IR}_{i} * {M}_{{Absolute}_{i}}^{2} )}{{\sum }^{i} ( {IR}_{i} * {M}_{{Absolute}_{i}} )} . \qquad ( EQ 9 )$$

Calculation of the cumulative detector fractions (CDF) for the low angle laser light scattering detector (“CDF_{Ls}”) can accomplished as follows. 1) Linearly flow correct the chromatogram based on the relative retention volume ratio of the air peak between the sample and that of a consistent narrow standards cocktail mixture. 2) Correct the light scattering detector offset (effective offset) relative to the IR5 as previously described. 3) Calculate the molecular weights at each retention volume (RV) data slice based on the polystyrene calibration curve, modified by the polystyrene to polyethylene conversion factor of approximately (0.395-0.440) as previously described. 4) Subtract baselines from the light scattering and IR5 chromatograms and set integration windows using standard GPC practices making certain to integrate all of the low molecular weight retention volume range in the light scattering chromatogram that is observable from the IR5 chromatogram (thus setting the highest RV limit to the same index in each chromatogram). Do not include any material in the integration which corresponds to less than 150 Dalton in either chromatogram. 5) Calculate the cumulative detector fraction (CDF_{Ls}) of the Low-Angle Laser Light Scattering (LALLS) chromatogram (CDF_{Ls}) based on its baseline-subtracted peak height (H) from high to low molecular weight (low to high retention volume) at each data slice (j) according to the following equation:

$${CDF}_{LS \geq 1 , 000 , 000 MW} = \frac{{\sum }_{j = RV at Lowest Integrated Volume}^{j = RV at 1 , 000 , 000 MW} Hj}{{\sum }_{j = RV at Lowest Integrated Volume}^{j = RV at Highest Integrated Volume} Hj} \qquad Equation 10$$

As shown in the Examples section, each of hydrogenation-catalyst treated polyethylene-1 and hydrogenation-catalyst treated polyethylne-2 had a CDF_{Ls} greater than 100*(0.0536-121*0.00224) %, in contrast to each of non-hydrogenation-catalyst treated polyethylenes A-B, which each had a CDF_{Ls} less than 100*(0.0536-I₂₁*0.00224) %.

The hydrogenation-catalyst treated polyethylene can have an absolute weight average molecular weight (M_{w} (Abs)) from 90,000 to 300,000 g/mol. All individual values and subranges from 90,000 to 300,000 g/mol are included; for example, the hydrogenation-catalyst treated polyethylene can have an M_{w} (Abs) from a lower limit of 90,000, 95,000, or 100,000 g/mol to an upper limit of 300,000, 250,000, or 200,000 g/mol. M_{w} (Abs) can be determined by absolute gel permeation chromatography (GPC), as is known in the art. Absolute GPC is discussed herein.

The hydrogenation-catalyst treated polyethylene can have an absolute number average molecular weight (Mn (Abs)) from 20,000 to 130,000 g/mol. All individual values and subranges from 20,000 to 130,000 g/mol are included; for example, the hydrogenation-catalyst treated polyethylene can have an Mn (Abs) from a lower limit of 20,000, 25,000, or 30,000 g/mol to an upper limit of 130,000, 100,000, or 85,000 g/mol. Mn (Abs) can be determined by absolute gel permeation chromatography (GPC), as is known in the art. Absolute GPC is discussed herein.

The hydrogenation-catalyst treated polyethylene can have an absolute Z-average molecular weight (M_{z} (Abs)) from 125,000 to 1,000,000 g/mol. All individual values and subranges from 125,000 to 1,000,000 g/mol are included; for example, the hydrogenation-catalyst treated polyethylene can have an M₂ (Abs) from a lower limit of 125,000, 150,000, or 200,000 g/mol to an upper limit of 1,000,000, 850,000, or 700,000 g/mol. M₂ (Abs) can be determined by absolute gel permeation chromatography (GPC), as is known in the art. Absolute GPC is discussed herein.

A method for comonomer content analysis (iCCD) has been previously disclosed (Cong and Parrott et al., see publication WO 2017040127A1) may be utilized. The iCCD test can be performed with Crystallization Elution Fractionation instrumentation (CEF) (PolymerChar, Spain) equipped with IR-5 detector (PolymerChar, Spain) and two angle light scattering detector Model 2040 (Precision Detectors, currently Agilent Technologies). A guard column packed can be with 20-27-micron glass (MoSCi Corporation, USA) in a 5 cm or 10 cm (length)×¼″ (ID) stainless cylinder installed just before the IR-5 detector in the detector oven. Ortho-dichlorobenzene (ODCB, 99% anhydrous grade or technical grade) can be used as solvent. Silica gel 40 (particle size 0.2˜0.5 mm, catalogue number 10181-3) from EMD Chemicals can be used to dry the ODCB solvent before. Dried silica can be packed into three emptied HT-GPC columns to further purify ODCB as eluent. The CEF instrument can be equipped with an autosampler with N₂ purging capability. ODCB can be sparged with dried nitrogen (N₂) for one hour before use. Sample preparation can be done with autosampler at 4 mg/ml (unless otherwise specified) under shaking at 160° C. for 1 hour. The injection volume can be 300 μl. The temperature profile of iCCD can be: crystallization at 3° C./min from 105° C. to 30° C., the thermal equilibrium at 30° C. for 2 minute (including Soluble Fraction Elution Time being set as 2 minutes), elution at 3° C./min from 30° C. to 140° C. The flow rate during crystallization can be 0.0 mL/min. The flow rate during elution can be 0.50 mL/min. The data can be collected at one data point/second.

The iCCD column can be packed with gold coated nickel particles (Bright 7GNM8-NiS, Nippon Chemical Industrial Co.) in a 15 cm (length)× ¼″ (ID) stainless tubing. The column packing and conditioning can be with a slurry method, e.g. see publication Cong, R.; Parrott, A.; Hollis, C.; Cheatham, WO 2017040127A1. The final pressure with TCB slurry packing can be 150 Bars.

Column temperature calibration can be performed by using a mixture of the Reference Material Linear homopolymer polyethylene (having zero comonomer content, Melt index (I₂) of 1.0 g/cm³, polydispersity Mw/Mn approximately 2.6 by conventional gel permeation chromatography at a concentration of 1.0 mg/mL) and Eicosane (2 mg/mL) in ODCB, iCCD temperature calibration can include four steps: (1) Calculating the delay volume defined as the temperature offset between the measured peak elution temperature of Eicosane minus 30.00° C.; (2) Subtracting the temperature offset of the elution temperature from iCCD raw temperature data. It is noted that this temperature offset is a function of experimental conditions, such as elution temperature, elution flow rate, etc.; (3) Creating a linear calibration line transforming the elution temperature across a range of 30.00° C. and 140.00° C. so that the linear homopolymer polyethylene reference had a peak temperature at 101.0° C., and Eicosane had a peak temperature of 30.0° C.; (4) For the soluble fraction measured isothermally at 30° C., the elution temperature below 30.0° C. is extrapolated linearly by using the elution heating rate of 3° C./min, e.g., according to Cerk and Cong et al., see U.S. Pat. No. 9,688,795.

The comonomer content versus elution temperature of iCCD can be constructed by using 12 reference materials (ethylene homopolymer and ethylene-octene random copolymer made with single site metallocene catalyst, having ethylene equivalent weight average molecular weight ranging from 35,000 to 128,000). All of these reference materials can be analyzed same way as specified previously at 4 mg/mL. The reported elution peak temperatures followed octene mole % versus elution temperature of iCCD at R2 of 0.978, where y=−6.315x/101.0000.

The h hydrogenation-catalyst treated polyethylene high density fraction (HDF) can be calculated as an integral from the iCCD curve from 93° C. to 119° C. This is defined as the integral of the IR-4 chromatogram (baseline subtracted measurement channel) in the elution temperature ranging from 93° C. to 119° C. divided by the total integral from 20° C. to 140° C. according to the following equation, where T is the elution temperature (from the calibration discussed above):

$$HDF = \frac{{\int }_{93.}^{119.} IRdT}{{\int }_{20.}^{140.} IRdT} * 100 \%$$

The complex viscosities and zero-shear viscosity (ZSV) value of the polyethylene material (no) can be obtained via the method described below. Rheological properties can be determined from 0.1 to 100 radians/second (rad/s) in a nitrogen environment at 190° C. and a strain amplitude of 10% in an ARES-G2 Advanced Rheometric Expansion System (TA Instrument) rheometer oven that is preheated for at least 30 minutes at 190° C. The disk, prepared by the Compression Molded Plaque Preparation Method (wherein resins are compression molded into circular plaques (3 mm thick×1 inch) at 350° F. for 5 minutes under 25000 psi pressure in air. Then the samples are taken out of the press to cool at room temperature), can be placed between two “25 mm” parallel plates in the oven. The gap can be slowly reduced between the “25 mm” parallel plates to 2.0 mm. The sample can remain for 5 minutes at these conditions. Then, the oven can be opened, and excess sample from around the edge of the plates can be trimmed. The oven can be closed and an additional five-minute delay can be used to allow for temperature equilibrium. Then, the complex viscosity can be determined via a small amplitude, oscillatory shear, according to an increasing frequency sweep from 0.1 to 100 rad/s to obtain the complex viscosities between 0.1 rad/s and 100 rad/s. The zero-shear viscosity (ZSV) value can be defined by TA instruments TRIOS software, which was estimated according to the Carreau-Yasuda model.

Composition distribution breadth index (CDBI) is defined as the weight percent of the polyethylenes molecules having a comonomer content within 50 percent of the median total molar comonomer content. For instance, if the median total molar comonomer content of a certain group of polyethylene molecules is found to be 4 mole percent, the CDBI of that group of i polyethylene molecules would be the weight percent of polyethylene molecules having a molar comonomer concentration from 2 to 6 mole percent. If 55 wt % of the polyethylene molecules had a molar comonomer content in the 2 to 6 mole percent range, the CDBI would be 55%. The CDBI of linear homopolymer polyethylene, which does not contain a comonomer, is defined to be 100%. The CDBI of a copolymer is readily calculated by data obtained from techniques well known in the art, such as, for example, temperature rising elution fractionation as described, for example, in U.S. Pat. No. 5,008,204 or in Wild et al.,J. Polv. Sci, Polv. Phvs.Ed., vol. 20, p. 441 (1982).

DMS (dynamic mechanical spectroscopy) frequency sweep is described as follows. For preparation, test samples were initially placed into a 1.5 in. diameter chase of thickness 3.10 mm and compression molded at a pressure of 25,000 lbs for 6.5 min. at 190° C. with a Carver Hydraulic Press (Model #4095.4NE2003). After cooling to room temperature, the sample was extracted to await rheological testing.

The DMS frequency sweep was conducted using 25 mm parallel plates at frequencies ranging from 0.1 to 100 rad/s. Test gap separating the plates was 2 mm and a strain that satisfies linear viscoelastic conditions was utilized, typically 10% strain. Each test was conducted under isothermal conditions and nitrogen atmosphere; common testing temperatures were 190° C., 210° C. and 230° C. Prior to initiating the DMS test, the rheometer oven was allowed to equilibrate at the desired testing temperature for at least 30 min. After the testing temperature has equilibrated, the sample was loaded into the rheometer, and the plates were gradually reduced to a gap of 2.8 mm and trimmed. The sample was then allowed to equilibrate for 2.5 min. before reducing the parallel plates to final test gap of 2 mm. Lastly, the sample was trimmed again to ensure that no bulge was present, and the test was initiated. During the test, the shear elastic modulus (G′), viscous modulus (G″) and complex viscosity were measured.

All DMS frequency tests were conducted on either ARES-G2 or DHR-3 rheometers, both of which were manufactured by TA Instruments. Data analyses were conducted via TA Instruments TRIOS software.

Melt strength can be determined by a Melt Strength Measurement process, as described as follows.

The melt Strength (MS) measurements were conducted on a Gottfert Rheotens 71.97 (Gottfert Inc.; Rock Hill, S.C.) attached to a Gottfert Rheotester 2000 or Rheograph 25 capillary rheometer. A polymer melt (about 20-30 grams, pellets) was extruded through a capillary die with a flat entrance angle (180 degrees) with a capillary diameter of 2.0 mm and an aspect ratio (capillary length/capillary diameter) of 15. After equilibrating the samples at 190° C. for 10 minutes, the piston was run at a constant speed to achieve an apparent wall shear rate of 38.16s⁻¹. The standard test temperature was 190° C. The sample was drawn uniaxially to a set of accelerating nips located 100 mm below the die, with an acceleration of 2.4 mm/s². Note that the spacing between these wheels are 0.4 mm. The tensile force was recorded as a function of the take-up speed of the nip rolls. Melt strength was reported as the plateau force (CN) before the strand broke. The following conditions were used in the melt strength measurements: apparent wall sear rate=38.16s⁻¹; wheel acceleration=2.4 mm/s²: capillary diameter=2.0 mm; and capillary length=30 mm.

The hydrogenation-catalyst treated polyethylene can have a melt strength (190° C.), as determined by the Melt Strength Measurement process described herein, from 7 to 15 (190° C.) centinewtons (CN). All individual values and subranges from 7 to 15 cN are included; for example, the hydrogenation-catalyst treated polyethylene can have a melt strength (190° C.) from a lower limit of 7, 8, or 9 cN to an upper limit of 15, 13, or 11 cN.

The hydrogenation-catalyst treated polyethylene can have a high density fraction (93-119° C.) from 5% to 30%. All individual values and subranges from 5% to 30% are included; for example, the hydrogenation-catalyst treated polyethylene can have a high density fraction (93-119° C.) from a lower limit of 5, 8, or 10% to an upper limit of 30, 28, or 25%. High density fraction (93-119° C.) may be determined as discussed herein, i.e., calculated as an integral from an iCCD curve from 93° C. to 119° C.

The hydrogenation-catalyst treated polyethylene can have a short chain branching distribution (SCBD) from 10 to 50. All individual values and subranges from 10 to 50 are included; for example, the hydrogenation-catalyst treated polyethylene can have a SCBD from a lower limit of 10, 12, or 15 to an upper limit of 50, 45, or 40. SCBD may be determined from data obtained from techniques known in the art, such as, for example, temperature rising elution fractionation (abbreviated herein as “TREF”) as described, for example, by Wild et al., Journal of Polymer Science, Poly. Phys. Ed., Vol. 20, p. 441 (1982), or in U.S. Pat. Nos. 4,798,081; 5,008,204; or by L. D. Cady, “The Role of Comonomer Type and Distribution in LLDPE Product Performance,” SPE Regional Technical Conference, Quaker Square Hilton, Akron, Ohio, October 1-2, pp. 107-119 (1985).

The hydrogenation-catalyst treated polyethylene can have a composition distribution breadth index (CDBI) from 35 to 80. All individual values and subranges from 35 to 80 are included; for example, the hydrogenation-catalyst treated polyethylene can have a CDBI from a lower limit of 35, 45, or 55 to an upper limit of 80, 75, or 70. CDBI may be determined from data obtained from techniques known in the art, such as, for example, temperature rising elution fractionation (abbreviated herein as “TREF”) as described, for example, by Wild et al., Journal of Polymer Science, Poly. Phys. Ed., Vol. 20, p. 441 (1982), or in U.S. Pat. Nos. 4,798,081; 5,008,204; or by L. D. Cady, “The Role of Comonomer Type and Distribution in LLDPE Product Performance,” SPE Regional Technical Conference, Quaker Square Hilton, Akron, Ohio, October 1-2, pp. 107-119 (1985).

The hydrogenation-catalyst treated polyethylene can have an Instrumented Dart Impact (IDI) Total Energy from 4.0 to 25.0 J; for instance, for a film having a 2 mil thickness and made as discussed herein All individual values and subranges from 4.0 to 25.0 J are included; for example, the hydrogenation-catalyst treated polyethylene can have an Instrumented Dart Impact (IDI) Total Energy from a lower limit of 4.0, 4.5, or 5.0 J to an upper limit of 25.0, 20.0, or 18.0 J. Instrumented Dart Impact (IDI) Total Energy can be determined according to ASTM D3763-18.

The hydrogenation-catalyst treated polyethylene can have an Instrumented Dart Impact (IDI) Peak Force greater than 315 Newtons (N). For instance, the hydrogenation-catalyst treated polyethylene can have an Instrumented Dart Impact (IDI) Peak Force from 315 to 450 N. All individual values and subranges from 315 to 450 N are included; for example, the hydrogenation-catalyst treated polyethylene can have an Instrumented Dart Impact (IDI) Peak Force from a lower limit of 315, 320, 323, or 325 N to an upper limit of 450, 400, 375, or 350 N. Instrumented Dart Impact (IDI) Peak Force can be determined according to ASTM D3763-18.

One or more embodiments provide that the hydrogenation-catalyst treated polyethylene can have a an Instrumented Dart Impact (IDI) Peak Energy of greater than 320 Newtons and have a cumulative detector fraction (CDF_{Ls}) at a molecular weight of ≥1,000,000 g/mol of greater than 4%. For instance, the hydrogenation-catalyst treated polyethylene can have a cumulative detector fraction (CDF_{Ls}) at a molecular weight of ≥1,000,000 g/mol of 4% to 12%. All individual values and subranges from 4% to 12% are included; for example, the hydrogenation-catalyst treated polyethylene can have a cumulative detector fraction (CDF_{Ls}) at a molecular weight of ≥1,000,000 g/mol from a lower limit of 4, 4.5 or 5% to an upper limit of 12, 10, or 8%. CDF_{Ls} can be determined as previously discussed.

As mentioned, the thermoplastic compositions disclosed herein comprising a virgin raw polymer, e.g., hydrogenation-catalyst treated polyethylene, and a recycled polyethylene. The term “recycled polyethylene” refers to polymers, e.g., polyethylenes, recovered from post-consumer material as defined by ISO 14021, polymers recovered from pre-consumer material as defined by ISO 14021, and combinations thereof. The generic term post-consumer recycled polyethylene thus includes blends of polymers recovered from materials generated by households or by commercial, industrial, and institutional facilities in their role as end-users of the material, which can no longer be used for its intended purpose. The generic term post-consumer recycled polyethylene also includes blends of polymers recovered from returns of materials from the distribution chain. The generic term pre-consumer recycled polyethylene thus includes blends of polymers recovered from materials diverted from the waste stream during a manufacturing process. The generic term pre-consumer recycled polyethylene excludes the reutilization of materials, such as rework, regrind, or scrap, generated in a process and capable of being reclaimed within the same process that generated it. The recycled polyethylene may include polyethylene or a blend of polyethylene recovered from post-consumer material, pre-consumer material, or combinations thereof. The terms “pre-consumer recycled polymer”, “PCR”, and “post-industrial recycled polymer” may be utilized to refer to “recycled polyethylene”. One or moe embodiments provide that the recycled polyethylene comprises either a first blend of polyethylenes recovered from post-consumer material, a second blend of polyethylenes recovered from pre-consumer material, or a combination of the first and second blends.

The recycled polyethylene may include one or more contaminants. The contaminants may be the result of the polymeric material's use prior to being repurposed for reuse. For example, contaminants may include paper, ink, food residue, or other recycled materials in addition to the polymer, which may result from a recycling process. PCR, e.g., recycled polyethylene, is distinct from virgin polymeric material. A virgin polymeric material, e.g., “virgin raw polymer” as previously mentioned, does not include materials previously used in a consumer or industry application. Virgin polymeric material has not undergone, or otherwise has not been subject to, a heat process or a molding process, after the initial polymer manufacturing process. The physical, chemical, and flow properties of PCR resins differ when compared to virgin polymeric resin, which in turn can present challenges to incorporating PCR into formulations for commercial use.

The PCR, e.g., recycled polyethylene, can include various compositions. PCR may be sourced from HDPE packaging such as bottles (milk jugs, juice containers), LDPE/LLDPE packaging such as films. PCR also includes residue from its original use, residue such as paper, adhesive, ink, nylon, ethylene vinyl alcohol (EVOH), polyethylene terephthalate (PET), and other odor-causing agents. Sources of PCR can include, for example, bottle caps and closures, milk, water or orange juice containers, detergent bottles, office automation equipment (printers, computers, copiers, etc.), white goods (refrigerators, washing machines, etc.), consumer electronics (televisions, video cassette recorders, stereos, etc.), automotive shredder residue (the mixed materials remaining after most of the metals have been sorted from shredded automobiles and other metal-rich products “shredded” by metal recyclers), packaging waste, household waste, rotomolded parts (kayaks/coolers), building waste and industrial molding and extrusion scrap.

In one or more embodiments, the PCR can comprise low density polyethylene, linear low-density polyethylene, or a combination thereof. In embodiments, the PCR can further comprise residue from its original use, such as paper, adhesive, ink, nylon, ethylene vinyl alcohol (EVOH), polyamide (PA), polyethylene terephthalate (PET), and other organic or inorganic material. Recycled polyethylenes are commercially available. Examples of PCR include AVANGARD NATURA PCR-LDPCR-100 (“AVANGARD 100”) and AVANGARD NATURA PCR-LDPCR-150 (“AVANGARD 150”) (commercially available from Avangard Innovative LP, Houston, Texas) . . . . Another example of commercially available recycled polyethylene is NATURA LDPE PCR 100, from Avangard Innovative LP.

In one or more embodiments, the recycled polyethylene may have a density from 0.900 to 0.940 g/cm³. All individual values and subranges of from 0.900 to 0.940 g/cm³ are disclosed and incorporated herein; for example the recycled polyethylene may have a density from a lower limit of 0.900, 0.905, or 0.910 to an upper limit of 0.940, 0.935, 0.930, or 0.925 g/cm³.

In one or more embodiments, the recycled polyethylene may have a melt index (I₂) from 0.30 dg/min to 6.00 dg/min. All individual values and subranges of from 0.30 dg/min to 6.00 dg/min are disclosed and incorporated herein; for example the recycled polyethylene may have a melt index (I₂) from a lower limit 0.30, 0.80, 1.00, 1.25, 1.50, or 1.80 dg/min to an upper limit of 6.00, 5.00, 4.00, 3.50, 3.00, or 2.80 dg/min.

Differential scanning calorimetry (DSC) is a known technique that can be used to examine the melting and crystallization of polymers. General principles of DSC measurements and applications of DSC to studying semi-crystalline polymers are described in standard texts (e.g., E. A. Turi, ed., Thermal Characterization of Polymeric Materials, Academic Press, 1981).

In preparation for Differential Scanning calorimetry (DSC) testing, pellet-form samples are first loaded into a 1 in. diameter chase of 0.13 mm thickness and compression molded into a film under 25,000 lbs of pressure at 190° C. for approximately 10 seconds. The resulting film is then cooled to room temperature. After which, the film is subjected to a punch press to extract a disk that fits the DSC test pan (Aluminum Tzero). The disk is then weighed individually (sample weight can be approximately 5-6 mg) and placed into the aluminum Tzero pan and sealed before being inserted into the DSC test chamber.

In accordance to ASTM standard D3418, the DSC test is conducted using a heat-cool-heat cycle. First, the sample is equilibrated at 180° C. and held isothermally for 5 min to remove thermal and process history. The sample is then quenched to −40° C. at a rate of 10° C./min and held isothermally once again for 5 min during the cool cycle. Lastly, the sample is heated at a rate of 10° C./min to 150° C. for the second heating cycle. For data analysis, the melting temperatures and enthalpy of fusion is extracted from the second heating curve, whereas the enthalpy of crystallization is taken from the cooling curve. The enthalpy of fusion and crystallization were obtained by integrating the DSC thermogram from −20° C. to the end of melting and crystallization, respectively. The tests were performed using the TA Instruments Q2000 and Discovery DSCs, and data analyses were conducted via TA Instruments Universal Analysis and TRIOS software packages.

In one or more embodiments, the recycled polyethylene, may have a melting point (Tm) greater than or equal to 105° C., such as greater than or equal to 110° C., greater than or equal to 115° C., greater than or equal to 120° C., greater than or equal to 125° C., or greater than or equal to 130° C. The recycled polyethylene may also have a melting point (Tm) less than or equal to 135° C., such as less than or equal to 130° C., less than or equal to 125° C., less than or equal to 120° C., less than or equal to 115° C., or less than or equal to 110° C. For example, the post-consumer recycled polyethylene may also have a melting point (Tm) of from 105° C. to 135° C., from 105° C. to 130° C., from 105° C. to 125° C., from 105° C. to 120° C., from 105° C. to 115° C. from 105° C. to 110° C., from 110° C. to 135° C., from 110° C. to 130° C., from 110° C. to 125° C., from 110° C. to 120° C., from 110° C. to 115° C., from 115° C. to 135° C., from 115° C. to 130° C., from 115° C. to 125° C., from 115° C. to 120° C., from 120° C. to 135° C., from 120° C. to 130° C., from 120° C. to 125° C., from 125° C. to 135° C., from 125° C. to 130° C., or from 130° C. to 135° C. Melting point may be determined by the DSC method discussed herein.

In one or more embodiments, the recycled polyethylene may have a heat of fusion from 120 to 230 Joule/gram (J/g). All individual values and subranges of from 120 to 230 J/g are disclosed and incorporated herein; for example, the heat of fusion of the PCR can be from a lower limit of 120, 125, 130, 135, 140, 145, or 155 J/g to an upper limit of 230, 220, 210, 200, 190, 180, or 170 J/g. Heat of fusion may be determined by the DSC method discussed herein.

In one or more embodiments, the recycled polyethylene may have a count of defect with an equivalent circular diameter in the range of 200-400 μm (per 24.6 cm³ of film) greater than 500, or greater than 800, or greater than 1000, greater than 2000, greater than 3500, greater than 5000, or greater than 6500. The recycled polyethylene can have a count of defect with an equivalent circular diameter in the range of 400-800 μm (per 24.6 cm³ of film) greater than 250, or greater than 400, or greater than 500, greater than 1000, greater than 2000, or greater than 3000. A typical virgin raw polymer has a defect count of 200-400 μm (per 24.6 cm³ of film) less than 100 and a defect count of 400-800 μm (per 24.6 cm³ of film) less than 100. Recycled polyethylenes have a higher defect count due to contamination and because the materials have been made into an article, used, and recovered. The processing means that the material has gone through at least two or at least three prior thermal cycles of heating and cooling.

The Defect Count is a measure of defects that are detected in an extruded film using optical imaging technology according the practices and guidance in ASTM D7310-20 “Standard Practice for Defect Detection and Rating of Plastic Film Using Optical Sensors.” The Defect Count is reported as the number of optical defects per 24.6 cm³ with an effective circular diameter within defined series of ranges: 200-400 μm, 400-800 μm, 800-1600 μm, 1600 μm and above. It is measured by an Optical Control Systems Film Surface Analyzer FSA100 (OCS FSA 100) optical imaging system. The OCS FSA100 optical imaging system consists of a lighting unit, a CCD line scan camera, and a computer with image/data analysis software version 5.0.4.6.

The OCS FSA100 optical imaging system detects defects as they obscure the transmission of halogen-based source light. Average greyscale was set to 170 with a threshold sensitivity setting of 35%. Additionally, the gain of the CCD system may be adjusted to compensate for film haziness. The imaging system creates a composite area of each defect by adding the defective pixels from each subsequent line scan. The system then reports the number of defects which were in user defined size ranges, based on the diameter of circles having equivalent areas.

Film fabrication is accomplished by an OCS ME19 cast film extrusion system equipped with a fixed lip coat hanger die. Die gap is 500 μm by 15 cm. It is a single screw extruder equipped with a 19 mm screw provided by OCS. The screw design is a 3:1 L/D compression ratio with a pineapple mixing tip. Total extrusion system mass output is 10±5 kg/hour. Film thickness was 38 μm, which was achieved via adjustment of the chill roll. A nitrogen purge was used at the feed throat of the extruder. Temperature profiles ranged from 135° C.-190° C. to achieve a target extrusion pressure of 220-240Bar. PCR resin was analyzed neat unless it was not possible to be extruded at 100% on the OCS system. If the PCR resin could not be processed neat it was diluted (50/50 Wt %) with virgin PE material in dry blend prior to extrusion. The virgin polyethylene used for dilution was an LDPE with a melt index in the range of 0.2-1 g/10 min (190° C.), and a density in the range of 0.919-0.923 g/cm³. (e.g. DOW Polyethylene 1321 Low Density, hereafter referred to as LDPE 1321). Embodiments provide that the thermoplastic composition is from 80 wt % to 25 wt % virgin raw polymer, e.g., the hydrogenation-catalyst treated polyethylene, based upon a total weight of the virgin raw polymer and the recycled polyethylene. All individual values and subranges from 80 wt % to 25 wt % are included; for example, the thermoplastic composition can be from an upper limit of 80, 75, 70, 65, 60, 55, or 50 wt % of the virgin raw polymer to a lower limit of 25, 30, 35, 40, 45, or 50 wt % of the virgin raw polymer based upon the total weight of the virgin raw polymer and the recycled polyethylene. On or more embodiments provide that the thermoplastic composition is from 75 wt % to 50 wt % virgin raw polymer based upon a total weight of the virgin raw polymer and the recycled polyethylene.

Embodiments provide that the thermoplastic composition is from 20 wt % to 75 wt % recycled polyethylene, based upon a total weight of the virgin raw polymer and the recycled polyethylene. All individual values and subranges from 20 wt % to 75 wt % are included; for example, the thermoplastic composition can be from a lower limit of 20, 25, 30, 35, 40, 45, or 50 wt % of the recycled polyethylene to an upper limit of 75, 70, 65, 60, 55, or 50 wt % of the recycled polyethylene based upon the total weight of the virgin raw polymer and the recycled polyethylene. On or more embodiments provide that the thermoplastic composition is from 25 wt % to 50 wt % recycled polyethylene based upon a total weight of the virgin raw polymer and the recycled polyethylene.

In one or more embodiments, the 12 of the recycled polyethylene is greater than k+12 of the virgin raw polymer, where k is 1.0 to 30. One or more embodiments provide that k is 1.5 to 20. One or more embodiments provide that k is 2.0 to 15. Embodiments provide that k can be from 1.0 to 30. All individual values and subranges from 1.0 to 30 are included; for example k can be from a lower limit of 1.0, 1.1, 1.5, or 2.0 to an upper limit of 30, 20, or 15.

As mentioned, advantageously the thermoplastic compositions disclosed herein provide select processability parameters, e.g., a combination of properties, that are desirable for a number of applications. For example, the thermoplastic compositions can have a desirable complex viscosity, e.g., a complex viscosity at 100 rad/s (190° C.) from 2500 to 3900 Pas, while also having a desirable melt strength, e.g., a melt strength (190° C.) from 7 to 15 cN.

The thermoplastic compositions can have a complex viscosity at 100 rad/s (190° C.) from 2500 to 3900 Pa*s. All individual values and subranges from 2500 to 3900 Pa*s are included; for example, the thermoplastic composition can have a complex viscosity at 100 rad/s (190° C.) from a lower limit of 2500, 2550, or 2600 Pa*s to an upper limit of 3900, 3825 or 3750 Pa*s. Complex viscosity is a well know parameter. Complex r viscosity at 100 rad/s (190° C.) can be determined as discussed herein.

The thermoplastic compositions can have a melt strength (190° C.) from 7 to 15 cN. All individual values and subranges from 7 to 15 cN are included; for example, the thermoplastic composition can have a melt strength (190° C.) from a lower limit of 7.0 or 7.1 cN to an upper limit of 15, 14, 13, or 12 cN. Melt strength is a well know parameter. Melt strength can be determined as discussed herein.

The thermoplastic compositions can have an Instrumented Dart Impact (IDI) Peak Force from 30 to 110 N. All individual values and subranges from 30 to 110 N are included; for example, the thermoplastic composition can have an Instrumented Dart Impact (IDI) Peak Force from a lower limit of 30, 32, or 34 N to an upper limit of 110, 100, or 90 N. Instrumented Dart Impact (IDI) Peak Force can be determined according to ASTM D3763-18.

The thermoplastic compositions can have an Instrumented Dart Impact (IDI) Total Energy from 0.2 to 10 J. All individual values and subranges from 0.2 to 10 J are included; for example, the thermoplastic composition can have an Instrumented Dart Impact (IDI) Total Energy from a lower limit of 0.2, 0.3, or 0.4 J to an upper limit of 10, 8, or 7 J. Instrumented Dart Impact (IDI) Total Energy can be determined according to ASTM D3763-18.

One or more embodiments provide a method for providing select processability parameters. The method includes contacting a zirconocene catalyst and a hydrogenation catalyst with ethylene and hexene in a gas-phase reactor under polymerizable conditions, wherein the zirconocene catalyst and the hydrogenation catalyst have a titanium to zirconium molar ratio from 0.100 to 0.700 to make a hydrogenation-catalyst treated polyethylene having a melt index (I₂) from 0.1 to 1.0 dg/min, a density from 0.850 to 0.940 g/cm³, a melt index (I₂₁) from 0.1 to 50 dg/min, a melt index (I₂₁/12) ratio less than or equal to 18.5, a M_{w} (Abs)/Mn (Abs) from 2.0 to 3.5, a M_{z} (Abs)/M_{w} (Abs) from 1.7 to 4.5, and a cumulative detector fraction (CDF_{Ls}) at a molecular weight of >1,000,000 g/mol of greater than 100*(0.0536-121*0.00224) %; and combining the hydrogenation-catalyst treated polyethylene with a recycled polyethylene to make a thermoplastic composition, wherein the recycled polyethylene comprises either a first blend of polyethylenes recovered from post-consumer material, a second blend of polyethylenes recovered from pre-consumer material, or a combination of the first and second blends; and wherein the recycled polyethylene has: a density of from 0.900 g/cm³ to 0.940 g/cm³ when measured according to ASTM D792-08, Method B; a melt index (I₂) of from 0.30 dg/min to 6.00 dg/min when measured according to ASTM D1238-10, Method B, at 190° C. and a 2.16 kg load, wherein the hydrogenation-catalyst treated polyethylene is from 80 wt % to 25 wt % of the thermoplastic composition based upon a total weight of the hydrogenation-catalyst treated polyethylene and the recycled polyethylene, and the recycled polyethylene is from 20 to 75 wt % of the thermoplastic composition based upon the total weight of the hydrogenation-catalyst treated polyethylene and the recycled polyethylene.

Embodiments provide the select processability parameters comprise complex viscosity at 100 rad/s (190° C.) and melt strength (190° C.), and wherein the thermoplastic composition has a complex viscosity at 100 rad/s (190° C.) from 2500 to 3900 Pa*sand a melt strength (190° C.) from 7 to 15 cN.

A number of aspects of the present disclosure are provided as follows.

Aspect 1 provides a thermoplastic composition comprising: a virgin raw polymer, wherein the virgin raw polymer comprises a hydrogenation-catalyst treated polyethylene, and the virgin raw polymer has a melt index (I₂) from 0.1 to 1.0 dg/min, a density from 0.850 to 0.940 g/cm³, a melt index (I₂₁) from 0.1 to 50 dg/min, a melt index (I₂₁/12) ratio less than or equal to 18.5, a M_{w} (Abs)/Mn (Abs) from 2.0 to 3.5, a M_{z} (Abs)/M_{w} (Abs) from 1.7 to 4.5, and a cumulative detector fraction (CDF_{Ls}) at a molecular weight of >1,000,000 g/mol of greater than 100*(0.0536-121*0.00224) %; and a recycled polyethylene wherein the recycled polyethylene comprises either a first blend of polyethylenes recovered from post-consumer material, a second blend of polyethylenes recovered from pre-consumer material, or a combination of the first and second blends; and wherein the recycled polyethylene has: a density of from 0.900 g/cm³ to 0.940 g/cm³ when measured according to ASTM D792-08, Method B; a melt index (I₂) of from 0.30 dg/min to 6.00 dg/min when measured according to ASTM D1238-10, Method B, at 190° C. and a 2.16 kg load, wherein the virgin raw polymer is from 80 wt % to 25 wt % of the thermoplastic composition based upon a total weight of the virgin raw polymer and the recycled polyethylene, and the recycled polyethylene is from 20 to 75 wt % of the thermoplastic composition based upon the total weight of the virgin raw polymer and the recycled polyethylene.

In some embodiments, the hydrogenation-catalyst treated polyethylene of Aspect 1 also has at least one, alternatively each of properties (a) and (b): (a) a ratio of M_{w} (Conv)/Mn(Conv) from 2.0 to 3.5, wherein M_{w} (Conv) is weight-average molecular weight and Mn(Conv) is number-average molecular weight, both measured by Gel Permeation Chromatography (GPC) Test Method 1 (GPC (conv)); (b) a ratio of M_{z} (Conv)/M_{w} (Conv) from 1.7 to 4.5, wherein M_{z} (Conv) is Z-average molecular weight and M_{w} (Conv) is weight-average molecular weight, both measured by Gel Permeation Chromatography (GPC) Test Method 1 (GPC (conv)).

Aspect 2 provides the thermoplastic composition of Aspect 1, wherein the thermoplastic composition has a complex viscosity at 100 rad/s (190° C.) from 2500 to 3900 Pa*s.

Aspect 3 provides the thermoplastic composition of Aspect 1 or Aspect 2, wherein the thermoplastic composition has a melt strength (190° C.) from 7 to 15 cN.

Aspect 4 provides the thermoplastic composition of Aspect 1, Aspect 2, and/or Aspect 3, wherein the thermoplastic composition has an Instrumented Dart Impact (IDI) Peak Force from 30 to 110 N.

Aspect 5 provides the thermoplastic composition of Aspect 1, Aspect 2, Aspect 3, and/or Aspect 4, wherein the virgin raw polymer is an ethylene/1-hexene copolymer, an ethylene/1-butene copolymer, an ethylene/1-octene copolymer, or a combination thereof.

Aspect 6 provides the thermoplastic composition of Aspect 1, Aspect 2, Aspect 3, Aspect 4, and/or Aspect 5, wherein the recycled polyethylene has a count of defect with an equivalent circular diameter in the range of 200-400 μm (per 24.6 cm³ of film) greater than 500, and a count of defect with an equivalent circular diameter in the range of 400-800 μm (per 24.6 cm³ of film) greater than 250.

Aspect 7 provides the thermoplastic composition of Aspect 1, Aspect 2, Aspect 3, Aspect 4, Aspect 5, and/or Aspect 6, wherein, wherein the recycled polyethylene has a differential scanning calorimeter (DSC) second heat of fusion of 120 J/g to 230 J/g.

Aspect 8 provides the thermoplastic composition of Aspect 1, Aspect 2, Aspect 3, Aspect 4, Aspect 5, Aspect 6, and/or Aspect 7, wherein the 12 of the recycled polyethylene is greater than k*12 of the virgin raw polymer, where k is 1.0 to 30.Aspect 9 provides a thermoplastic composition comprising: a virgin raw polymer, wherein the virgin raw polymer comprises a hydrogenation-catalyst treated polyethylene, and the virgin raw polymer has a melt index (I₂) from 0.1 to 1.0 dg/min, a density from 0.850 to 0.940 g/cm³, a melt index (I₂₁) from 0.1 to 50 dg/min, an Instrumented Dart Impact (IDI) Peak Force greater than 315 Newtons, and a cumulative detector fraction (CDF_{Ls}) at a molecular weight of >1,000,000 g/mol of greater than 4%; and a recycled polyethylene, wherein the recycled polyethylene comprises either a first blend of polyethylenes recovered from post-consumer material, a second blend of polyethylenes recovered from pre-consumer material, or a combination of the first and second blends; and wherein the recycled polyethylene has: a density of from 0.900 g/cm³ to 0.940 g/cm³ when measured according to ASTM D792-08, Method B; a melt index (I₂) of from 0.30 dg/min to 6.00 dg/min when measured according to ASTM D1238-10, Method B, at 190° C. and a 2.16 kg load, wherein the virgin raw polymer is from 80 wt % to 25 wt % of the thermoplastic composition based upon a total weight of the virgin raw polymer and the recycled polyethylene, and the recycled polyethylene is from 20 to 75 wt % of the thermoplastic composition based upon the total weight of the virgin raw polymer and the recycled polyethylene.

Aspect 10 provides the thermoplastic composition of Aspect 9, wherein the the virgin raw polymer has a has a cumulative detector fraction (CDF_{Ls}) at a molecular weight of ≥1,000,000 g/mol of greater than 100*(0.0536-I₂₁*0.00224) %.

Aspect 11 provides the polyolefin composition of Aspect 9 and/or Aspect 10 wherein the thermoplastic composition has a complex viscosity at 100 rad/s (190° C.) from 2500 to 3900 Pa*s, a melt strength (190° C.) from 7 to 15 cN, and an Instrumented Dart Impact (IDI) Peak Force from 30 to 110 N).

Aspect 12 provides a method for providing select processability parameters, the method comprising: contacting a zirconocene catalyst and a hydrogenation catalyst with ethylene and hexene in a gas-phase reactor under polymerizable conditions, wherein the zirconocene catalyst and the hydrogenation catalyst have a titanium to zirconium molar ratio from 0.100 to 0.700 to make a hydrogenation-catalyst treated polyethylene having a melt index (I₂) from 0.1 to 1.0 dg/min, a density from 0.850 to 0.940 g/cm³, a melt index (I₂₁) from 0.1 to 50 dg/min, a melt index (I₂₁/12) ratio less than or equal to 18.5, a M_{w} (Abs)/Mn (Abs) from 2.0 to 3.5, a M_{z} (Abs)/M_{w} (Abs) from 1.7 to 4.5, and a cumulative detector fraction (CDF_{Ls}) at a molecular weight of >1,000,000 g/mol of greater than 100*(0.0536-121*0.00224) %; and combining the hydrogenation-catalyst treated polyethylene with a recycled polyethylene to make a thermoplastic composition, wherein the recycled polyethylene comprises either a first blend of polyethylenes recovered from post-consumer material, a second blend of polyethylenes recovered from pre-consumer material, or a combination of the first and second blends; and wherein the recycled polyethylene has: a density of from 0.900 g/cm³ to 0.940 g/cm³ when measured according to ASTM D792-08, Method B; a melt index (I₂) of from 0.30 dg/min to 6.00 dg/min when measured according to ASTM D1238-10, Method B, at 190° C. and a 2.16 kg load, wherein the hydrogenation-catalyst treated polyethylene is from 80 wt % to 25 wt % of the thermoplastic composition based upon a total weight of the hydrogenation-catalyst treated polyethylene and the recycled polyethylene, and the recycled polyethylene is from 20 to 75 wt % of the thermoplastic composition based upon the total weight of the hydrogenation-catalyst treated polyethylene and the recycled polyethylene.

Aspect 13 provides the method of Aspect 12, wherein the select processability parameters comprise complex viscosity at 100 rad/s (190° C.) and melt strength, and wherein the thermoplastic composition has a complex viscosity at 100 rad/s (190° C.) from 2500 to 3900 Pa*s and a melt strength (190° C.) from 7 to 15 cN.

In some embodiments, the hydrogenation-catalyst treated polyethylene of Aspect 12 also has at least one, alternatively each of properties (a) and (b): (a) a ratio of M_{w} (Conv)/Mn(Conv) from 2.0 to 3.5, wherein M_{w} (Conv) is weight-average molecular weight and Mn(Conv) is number-average molecular weight, both measured by Gel Permeation Chromatography (GPC) Test Method 1 (GPC (conv)); (b) a ratio of M_{z} (Conv)/M_{w} (Conv) from 1.7 to 4.5, wherein M_{z} (Conv) is Z-average molecular weight and M_{w} (Conv) is weight-average molecular weight, both measured by Gel Permeation Chromatography (GPC) Test Method 1 (GPC (conv)).

### EXAMPLES

For the Examples, XCAT™ HP-100 (zirconocene catalyst, obtained from Univation Technologies, LLC) was utilized.

Hydrogenation catalyst-1 (titanocene catalyst) was prepared as follows: a 1 L bottle was charged with 15.1 g of bis(cyclopentadienyl) titanium dichloride (Sigma-Aldrich), 527 mL of hexane, and a stir bar to form a suspended mixture. To this mixture, 60.3 g of triisobutylaluminum (neat, Sigma-Aldrich) was slowly add over 10 minutes while stirring. The solid Cp₂ TiCl₂ became soluble and formed a blue solution which was further diluted with isopentane to provide a 0.3 weight percent mixture.

Hydrogenation-catalyst treated polyethylene-1 (a virgin raw polymer and an ethylene/1-hexene copolymer) was made utilizing XCAT™ HP-100 and hydrogenation catalyst-1 as follows. XCAT™ HP-100 and hydrogenation catalyst-1 were separately fed into a gas-phase reactor to make a zirconocene/titanocene catalyst system in situ; the XCAT™ HP-100 was fed dry using nitrogen as carrier, and hydrogenation catalyst-1 was fed as liquid catalyst solution in isopentane. Then, ethylene was copolymerized with 1-hexene in the gas-phase reactor. The polymerization was continuously conducted after equilibrium was reached under conditions set forth in Table I.

Hydrogenation-catalyst treated polyethylene-2 was made as hydrogenation-catalyst treated polyethylene-1 with any changes indicated in Table 2.

Non-hydrogenation-catalyst treated polyethylenes-A-B were made as hydrogenation-catalyst treated polyethylene-1; however, hydrogenation catalyst-1 was not utilized for making non-hydrogenation-catalyst treated polyethylenes-A-B. Changes to utilized to make non-hydrogenation-catalyst treated polyethylenes-A-B, as compared to hydrogenation-catalyst treated polyethylene-1, are indicated in Tables 1-2.

TABLE 1

| | |
|---|---|
| | Non- |
| Hydrogenation- | hydrogenation- |
| catalyst treated | catalyst treated |
| polyethylene 1 | polyethylene A |

Conditions for gas-phase reactor

| | | |
|---|---|---|
| Reactor Temperature (° C.) | 85 | 85 |
| Reactor Pressure (psig) | 378 | 378 |
| C₂ partial pressure (psi) | 200 | 200 |
| H₂ to C₂ ratio (mol/mol) | 0.000069 | 0.00012 |
| C₆ to C₂ ratio (mol/mol) | 0.017 | 0.022 |
| Isopentane (mol %) | 4.99 | 4.94 |
| C₂ feed rate (lb/hr) | 40.7 | 35.5 |
| C₆ feed rate (lb/hr) | 1.949 | 2.129 |
| H₂ feed rate (millipound/hr) | — | — |
| Reactor vent (lb/hr) | 14.8 | 16.4 |
| Zr feed rate (from | 0.027 | 0.014 |
| zirconocene g/hr) | | |
| Titanocene solution feed rate | 107.7 | — |
| (cm³/hr) | | |
| Titanium to zirconium | 0.445 | — |
| (molar ratio) | | |
| Production rate (lb/hr) | 34.3 | 30.3 |
| Bed weight (lbs) | 156 | 152 |
| Residence time (hr) | 4.5 | 5.0 |

TABLE 2

| | |
|---|---|
| | Non- |
| Hydrogenation- | hydrogenation- |
| catalyst treated | catalyst treated |
| polyethylene 2 | polyethylene B |

Conditions for gas-phase reactor

| | | |
|---|---|---|
| Reactor Temperature (° C.) | 75 | 75 |
| Reactor Pressure (psig) | 378 | 377 |
| C₂ partial pressure (psi) | 201 | 201 |
| H₂ to C₂ ratio (mol/mol) | 0.000079 | 0.000159 |
| C₆ to C₂ ratio (mol/mol) | 0.034 | 0.034 |
| Isopentane (mol %) | 3.00 | 2.99 |
| C₂ feed rate (lb/hr) | 26.9 | 33.5 |
| C₆ feed rate (lb/hr) | 2.727 | 3.713 |
| H₂ feed rate (millipound/hr) | — | — |
| Reactor vent (lb/hr) | 14.0 | 14.1 |
| Zr feed rate (from | 0.049 | 0.024 |
| zirconocene g/hr) | | |
| Titanocene solution | 26.1 | — |
| feed rate (cm³/hr) | | |
| Titanium to zirconium | 0.210 | — |
| (molar ratio) | | |
| Production rate (lb/hr) | 20.7 | 30.0 |
| Bed weight (lbs) | 198 | 195 |
| Residence time (hr) | 9.6 | 6.5 |

A number of properties were determined for hydrogenation-catalyst treated polyethylenes 1-2 and non-hydrogenation-catalyst treated polyethylenes A-B. The results are reported in Tables 3-9.

Density was determined according to ASTM D792-08.

Melt index (12, 15, 110 and I₂₁) was determined according to ASTM D1238-10.

Cumulative detector fraction (CDF_{Ls}) was determined as discussed herein.

Weight average molecular weight (M_{w} (Conv)), number average molecular weight (Mn(Conv)), and Z-average molecular weight (M₂ (Conv)) were determined by conventional gel permeation chromatography (GPC).

Absolute weight average molecular weight (M_{w} (Abs)), absolute number average molecular weight (Mn (Abs)), and absolute Z-average molecular weight (M₂ (Abs)) were determined by absolute gel permeation chromatography (GPC).

High density fraction was determined as discussed herein, i.e., calculated as an integral from an iCCD curve from 93° C. to 119° C.

Short Chain Branching Distribution was determined as discussed herein.

CDBI was determined as discussed herein.

Zero shear viscosity was determined as discussed herein.

Melt strength (190° C.) was determined by the Melt Strength Measurement process, as discussed herein.

TABLE 4

| | Density | I₂ | I₅ | I₁₀ | I₂₁ | I₂₁/I₅ | I₂₁/I₂ |
|---|---|---|---|---|---|---|---|
| | (g/cm³) | (dg/min) | (dg/min) | (dg/min) | (dg/min) | (dg/min) | (dg/min) |
| Hydrogenation | 0.920 | 0.166 | 0.44 | 1.01 | 2.89 | 6.5 | 17.4 |
| polyethylene | | | | | | | |
| 1 | | | | | | | |
| Non-hydrogenation | 0.919 | 0.271 | 0.73 | 1.67 | 4.80 | 6.6 | 17.7 |
| polyethylene | | | | | | | |
| A | | | | | | | |
| Hydrogenation | 0.908 | 0.168 | 0.44 | 1.01 | 2.92 | 6.7 | 17.4 |
| polyethylene | | | | | | | |
| 2 | | | | | | | |
| Non-hydrogenation | 0.908 | 0.322 | 0.84 | 1.91 | 5.49 | 6.5 | 17.1 |
| polyethylene | | | | | | | |
| B | | | | | | | |

The data of Table 4 indicate that hydrogenation-catalyst treated polyethylene-1 and non-hydrogenation-catalyst treated polyethylene-A have similar density values and that hydrogenation-catalyst treated polyethylene-2 and non-hydrogenation-catalyst treated polyethylene-B have similar density values.

The data of Table 4 indicate that hydrogenation-catalyst treated polyethylene-1 and hydrogenation-catalyst treated polyethylene-2 each had a melt index (I₂) from 0.1 to 0.5 dg/min, which is desirable for a number of applications.

TABLE 5

| | Mn | Mw | Mz | | |
|---|---|---|---|---|---|
| | (Conv) | (Conv) | (Conv) | Mw(Conv)/ | Mz(Conv)/ |
| | g/mol | g/mol | g/mol | Mn (Conv) | Mw (Conv) |
| Hydrogenation-catalyst | 64,428 | 176,466 | 380,038 | 2.7 | 2.2 |
| treated polyethylene 1 | | | | | |
| Non-hydrogenation-catalyst | 56,433 | 152,919 | 318,058 | 2.7 | 2.1 |
| treated polyethylene A | | | | | |
| Hydrogenation-catalyst | 65,116 | 176,115 | 485,073 | 2.7 | 2.8 |
| treated polyethylene 2 | | | | | |
| Non-hydrogenation-catalyst | 55,474 | 145,618 | 287,036 | 2.6 | 2.0 |
| treated polyethylene B | | | | | |

TABLE 6

| | | | | | | CDF_{LS} | |
|---|---|---|---|---|---|---|---|
| | | | | | | (at a | |
| | | | | | | molecular | |
| | | | | | | weight | 100*(0.0536- |
| | Mn | Mw | Mz | Mw | Mz | (MW) of | I₂₁*0.00224) |
| | (Abs) | (Abs) | (Abs) | (Abs)/Mn | (Abs)/Mw | ≥1,000,000 | (reported as |
| | g/mol | g/mol | g/mol | (Abs) | (Abs) | g/mol) | percentage) |
| Hydrogenation- | 70,278 | 191,115 | 388,930 | 2.72 | 2.04 | 5.6% | 4.7% |
| catalyst treated | | | | | | | |
| polyethylene | | | | | | | |
| 1 | | | | | | | |
| Non- | 56,643 | 164,201 | 335,090 | 2.90 | 2.04 | 3.7% | 4.3% |
| hydrogenation- | | | | | | | |
| catalyst treated | | | | | | | |
| polyethylene | | | | | | | |
| A | | | | | | | |
| Hydrogenation- | 70,260 | 194,005 | 504,223 | 2.76 | 2.60 | 5.5% | 4.7% |
| catalyst treated | | | | | | | |
| polyethylene | | | | | | | |
| 2 | | | | | | | |
| Non- | 60,364 | 160,344 | 303,611 | 2.66 | 1.89 | 3.0% | 4.1% |
| hydrogenation- | | | | | | | |
| catalyst treated | | | | | | | |
| polyethylene | | | | | | | |
| B | | | | | | | |

The data of Table 6 indicate that each of hydrogenation-catalyst treated polyethylene-1 and hydrogenation-catalyst treated polyethylene-2 had a CDF_{Ls} at a molecular weight of ≥1,000,000 g/mol greater than 100*(0.0536-I₂₁*0.00224) %. The data of Table 6 indicate that each of hydrogenation-catalyst treated polyethylene-1 and hydrogenation-catalyst treated polyethylene-2 had a CDF_{Ls} at a molecular weight of ≥1,000,000 g/mol greater than 4%.

TABLE 7

| | | Short Chain | Composition |
|---|---|---|---|
| | High density | Branching | Distribution |
| | fraction | Distribution | Branching |
| | (93-119° C.) | (wt %) | Index |
| Hydrogenation-catalyst | 24.1% | 18.0 | 56 |
| treated polyethylene 1 | | | |
| Non-hydrogenation-catalyst | 18.7% | 15.5 | 60 |
| treated polyethylene A | | | |
| Hydrogenation-catalyst | 11.9% | 35.2 | 60 |
| treated polyethylene 2 | | | |
| Non-hydrogenation-catalyst | 8.9% | 33.8 | 66 |
| treated polyethylene B | | | |

TABLE 8

| | Zero shear viscosity | Melt strength |
|---|---|---|
| | (Pa-sec) | (cN) |
| Hydrogenation-catalyst treated | 4.35(10\hat{ }04) | 9.3 |
| polyethylene 1 | | |
| Non-hydrogenation-catalyst treated | 2.87(10\hat{ }04) | 6.0 |
| polyethylene A | | |
| Hydrogenation-catalyst treated | 4.27(10\hat{ }04) | 10.3 |
| polyethylene 2 | | |
| Non-hydrogenation-catalyst treated | 2.16(10\hat{ }04) | 6.4 |
| polyethylene B | | |

TABLE 9

| | Instrumented | Instrumented |
|---|---|---|
| | Dart Impact | Dart Impact |
| | Peak Force | Total Energy |
| | (N) | (J) |
| Hydrogenation-catalyst treated | 328.5 | 11.0 |
| polyethylene 1 | | |
| Non-hydrogenation-catalyst treated | 301.6 | 9.7 |
| polyethylene A | | |
| Hydrogenation-catalyst treated | 334.1 | 17.0 |
| polyethylene 2 | | |
| Non-hydrogenation-catalyst treated | 308.3 | 17.0 |
| polyethylene B | | |

Recycled polyethylene, (Natura LDPE PCR 100) was obtained from Avangard Innovative. A number of properties were determined for the recycled polyethylene. The results are reported in Table 5. Density was determined according to ASTM D792-08, Melt index (I₂) was determined according to ASTM D1238-10, Ash content was determined according to D5630, Moisture content was determined according to ASTM D6980, Color was determined according to ASTM D6290-19, defect count and heat of fusion were determined as discussed herein, where, for determining the defect count, the recycled polyethylene was diluted with 50% LDPE 1321 and the defect count was measured at 170° C.

TABLE 10

| | Recycled polyethylene |
|---|---|
| Density (g/cm³) | 0.910-0.925 |
| I₂ (dg/min) | 1.8-2.8 |
| Defect count in the range of 200-400 μm | 7164 |
| (Per 24.6 cm³) | |
| Defect count in the range of 400-800 μm | 3783 |
| (Per 24.6 cm³) | |
| 2^{nd} heat of fusion from DSC (J/g) | 120-230 |
| Moisture Content (%) | ≤0.05 |
| Color (L*) | ≥40 |
| Ash Content (%) | ≤1.0 |

Example 1-1, a thermoplastic composition, was made by a film process described below. Example 1-2 was made as Example 1-1, with any changes reported in Table 11.

Comparative Examples A-1 and A-2 were made as Example 1-1; however, non-hydrogenation-catalyst treated polyethylene-A was used rather than hydrogenation-catalyst treated polyethylene-1, with any changes reported in Table 11.

Examples 2-1 and 2-2 were made as Example 1-1; however, hydrogenation-catalyst treated polyethylene-2 was used rather than hydrogenation-catalyst treated polyethylene-1, with any changes reported in Table 11.

Comparative Examples B-1 and B-2 were made as Example 1-1; however, non-hydrogenation-catalyst treated polyethylene-B was used rather than hydrogenation-catalyst treated polyethylene-1, with any changes reported in Table 11.

TABLE 11

| | | Virgin Raw | Recycled |
|---|---|---|---|
| | | polymer | polyethylene |
| | Virgin Raw polymer | amount | amount |
| | utilized | (wt %) | (wt %) |
| Example 1-1 | Hydrogenation-catalyst | 75 | 25 |
| | treated polyethylene 1 | | |
| Comparative | Non-hydrogenation-catalyst | 75 | 25 |
| Example A-1 | treated polyethylene A | | |
| Example 1-2 | Hydrogenation-catalyst | 50 | 50 |
| | treated polyethylene 1 | | |
| Comparative | Non-hydrogenation-catalyst | 50 | 50 |
| Example A-2 | treated polyethylene A | | |
| Example 2-1 | Hydrogenation-catalyst | 75 | 25 |
| | treated polyethylene 2 | | |
| Comparative | Non-hydrogenation-catalyst | 75 | 25 |
| Example B-1 | treated polyethylene B | | |
| Example 2-2 | Hydrogenation-catalyst | 50 | 50 |
| | treated polyethylene 2 | | |
| Comparative | Non-hydrogenation-catalyst | 50 | 50 |
| Example B-2 | treated polyethylene B | | |

Complex viscosity at 100 rad/see (190° C.) was determined for Examples 1-1, 1-2, 2-1, 2-2 and Comparative Examples of virgin polyethylene resins Hydrogenation-catalyst treated polyethylene 1, Hydrogenation-catalyst treated polyethylene 2, Non-hydrogenation-catalyst treated polyethylene A, and Non-hydrogenation-catalyst treated polyethylene B. The results are reported in Table 12.

Complex viscosity was determined, as discussed herein, at 100 rad/s (190° C.).

TABLE 12

| | Complex viscosity |
|---|---|
| | at 100 rad/s |
| | (Pa*s) |
| Example 1-1 | 3620.8 |
| Example 1-2 | 2836.7 |
| Example 2-1 | 3511.9 |
| Example 2-2 | 2602.5 |
| Hydrogenation-catalyst treated | 5079.2 |
| polyethylene 1 (Comparative) | |
| Hydrogenation-catalyst treated | 4166.4 |
| polyethylene 2 (Comparative) | |
| Non-hydrogenation-catalyst treated | 4962.3 |
| polyethylene A (Comparative) | |
| Non-hydrogenation-catalyst treated | 3931.9 |
| polyethylene B (Comparative) | |

The data of Table 12 indicate that each of Examples 1-1, 1-2, 2-1, 2-2, in contrast to each of the Comparative Examples 2, had a complex viscosity at 100 rad/s (190° C.) from 2500 to 3900 Pa*s.

Monolayer blown films of 2.0 mil thickness targets were respectively made from Examples 1-1, 1-2, 2-1, 2-2 and Comparative Examples A-1, A-2, B-1, B-2 using a 2″ die diameter blown film line. Gravimetric feeders dosed resin formulations into a Labtech LTE20-32 twin screw extruder at rate of 15 lbs/hr. From the extruder the resin formulation is conveyed into the 2″ die diameter die with gap of 1.0 mm. The LTE feed throat was set to 193° C. and the remaining barrel, conveying portion, and die temperature were set and maintained to 215° C. To produce films an output rate of 2.4 lb/hr/in, of die circumference with pressurized ambient air inflating the film bubble to a 2.5 blow-up ratio. A dual lip air ring driven by a variable speed blower is used for all experiments. The frost line height (FLH) was maintained between 9.3 and 10.3 inches. Film thickness was targeted at 2 mils and was controlled within +10% by adjusting the nip roller speed. The films are wound up into a roll. Instrumented Dart Impact Total Energy (J) and Instrumented Dart Impact Peak Force (N) were determined according to ASTM D3763-18. Melt strength (190° C.) was determined by the Melt Strength Measurement Process, as discussed herein. The results are reported in Table 13.

TABLE 13

| | Instrumented | Instrumented | |
|---|---|---|---|
| | Dart Impact | Dart Impact | |
| | Peak Force | Total Energy | |
| | (N) | (J) | Melt strength |
| Example 1-1 | 52.1 | 1.16 | 11.8 |
| Comparative | 47.1 | 1.05 | 6.8 |
| Example A-1 | | | |
| Example 1-2 | 83.8 | 6.45 | 7.7 |
| Comparative | 72.2 | 5.16 | 5.7 |
| Example A-2 | | | |
| Example 2-1 | 34.4 | 0.49 | 10.4 |
| Comparative | 29.6 | 0.43 | 6.6 |
| Example B-1 | | | |
| Example 2-2 | 74.4 | 5.51 | 7.1 |
| Comparative | 66.4 | 4.72 | 5.6 |
| Example B-2 | | | |

The data of Table 13 indicate that each of Examples 1-1, 1-2, 2-1, 2-2 provided an improved Instrumented Dart Impact (IDI) Peak Force value, as respectively compared to each of Comparative Examples A-1, A-2, B-1, and B-2. The data of Table 13 indicate that each of Examples 1-1, 1-2, 2-1, 2-2 provided an Instrumented Dart Impact (IDI) Peak Force value from 30 to 110 cN.

The data of Table 13 indicate that each of Examples 1-1, 1-2, 2-1, 2-2 provided an improved Instrumented Dart Impact (IDI) Total Energy value, as respectively compared to each of Comparative Examples A-1, A-2, B-1, and B-2.

The data of Table 13 indicate that each of Examples 1-1, 1-2, 2-1, 2-2 provided an improved melt strength (190° C.), as respectively compared to each of Comparative Examples.

1. A thermoplastic composition comprising:
a virgin raw polymer, wherein the virgin raw polymer comprises a hydrogenation-catalyst treated polyethylene, and the virgin raw polymer has a melt index (I₂) from 0.1 to 1.0 dg/min, a density from 0.850 to 0.940 g/cm³, a melt index (I₂₁) from 0.1 to 50 dg/min, a melt index (I₂₁/12) ratio less than or equal to 18.5, a M_{w} (Abs)/Mₙ (Abs) from 2.0 to 3.5, a M_{z} (Abs)/M_{w} (Abs) from 1.7 to 4.5, and a cumulative detector fraction (CDF_{LS}) at a molecular weight of ≥1,000,000 g/mol of greater than 100*(0.0536-I₂₁*0.00224) %; and
a recycled polyethylene
wherein the recycled polyethylene comprises either a first blend of polyethylenes recovered from post-consumer material, a second blend of polyethylenes recovered from pre-consumer material, or a combination of the first and second blends; and
wherein the recycled polyethylene has:
a density of from 0.900 g/cm³ to 0.940 g/cm³ when measured according to ASTM D792-08, Method B;
a melt index (I₂) of from 0.30 dg/min to 6.00 dg/min when measured according to ASTM D1238-10, Method B, at 190° C. and a 2.16 kg load,
wherein the virgin raw polymer is from 80 wt % to 25 wt % of the thermoplastic composition based upon a total weight of the virgin raw polymer and the recycled polyethylene, and the recycled polyethylene is from 20 to 75 wt % of the thermoplastic composition based upon the total weight of the virgin raw polymer and the recycled polyethylene.

2. The thermoplastic composition of claim 1, wherein the thermoplastic composition has a complex viscosity at 100 rad/s (190° C.) from 2500 to 3900 Pa*s.

3. The thermoplastic composition of claim 1, wherein the thermoplastic composition has a melt strength (190° C.) from 7 to 15 cN.

4. The thermoplastic composition of claim 1, wherein the thermoplastic composition has an Instrumented Dart Impact (IDI) Peak Force from 30 to 110 N.

5. The thermoplastic composition of claim 1, wherein the virgin raw polymer is an ethylene/1-hexene copolymer, an ethylene/1-butene copolymer, an ethylene/1-octene copolymer, or a combination thereof.

6. The thermoplastic composition of claim 1, wherein the recycled polyethylene has a count of defect with an equivalent circular diameter in the range of 200-400 μm (per 24.6 cm³ of film) greater than 500, and a count of defect with an equivalent circular diameter in the range of 400-800 μm (per 24.6 cm³ of film) greater than 250.

7. The thermoplastic composition of claim 1, wherein the recycled polyethylene has a differential scanning calorimeter (DSC) second heat of fusion of 120 J/g to 230 J/g.

8. The thermoplastic composition of claim 1, wherein the I₂ of the recycled polyethylene is greater than k*I₂ of the virgin raw polymer, where k is 1.0 to 30.

9. A thermoplastic composition comprising:
a virgin raw polymer, wherein the virgin raw polymer comprises a hydrogenation-catalyst treated polyethylene, and the virgin raw polymer has a melt index (I₂) from 0.1 to 1.0 dg/min, a density from 0.850 to 0.940 g/cm³, a melt index (I₂₁) from 0.1 to 50 dg/min, an Instrumented Dart Impact (IDI) Peak Force greater than 315 Newtons, and a cumulative detector fraction (CDF_{LS}) at a molecular weight of ≥1,000,000 g/mol of greater than 4%; and
a recycled polyethylene,
wherein the recycled polyethylene comprises either a first blend of polyethylenes recovered from post-consumer material, a second blend of polyethylenes recovered from pre-consumer material, or a combination of the first and second blends; and
wherein the recycled polyethylene has:
a density of from 0.900 g/cm³ to 0.940 g/cm³ when measured according to ASTM D792-08, Method B;
a melt index (I₂) of from 0.30 dg/min to 6.00 dg/min when measured according to ASTM D1238-10, Method B, at 190° C. and a 2.16 kg load,
wherein the virgin raw polymer is from 80 wt % to 25 wt % of the thermoplastic composition based upon a total weight of the virgin raw polymer and the recycled polyethylene, and the recycled polyethylene is from 20 to 75 wt % of the thermoplastic composition based upon the total weight of the virgin raw polymer and the recycled polyethylene.

10. The thermoplastic composition of claim 9, wherein the virgin raw polymer has a has a cumulative detector fraction (CDF_{LS}) at a molecular weight of ≥1,000,000 g/mol of greater than 100*(0.0536-21*0.00224) %.

11. The thermoplastic composition of claim 9, wherein the thermoplastic composition has a complex viscosity at 100 rad/s (190° C.) from 2500 to 3900 Pa*s, a melt strength (190° C.) from 7 to 15 cN, and an Instrumented Dart Impact (IDI) Peak Force from 30 to 110 N.

12. A method for providing select processability parameters, the method comprising:
contacting a zirconocene catalyst and a hydrogenation catalyst with ethylene and hexene in a gas-phase reactor under polymerizable conditions, wherein the zirconocene catalyst and the hydrogenation catalyst have a titanium to zirconium molar ratio from 0.100 to 0.700 to make a hydrogenation-catalyst treated polyethylene having a melt index (I₂) from 0.1 to 1.0 dg/min, a density from 0.850 to 0.940 g/cm³, a melt index (I₂₁) from 0.1 to 50 dg/min, a melt index (I₂₁/12) ratio less than or equal to 18.5, a M_{w} (Abs)/Mₙ (Abs) from 2.0 to 3.5, a M_{z} (Abs)/M_{w} (Abs) from 1.7 to 4.5, and a cumulative detector fraction (CDF_{LS}) at a molecular weight of ≥1,000,000 g/mol of greater than 100*(0.0536-I₂₁*0.00224) %; and
combining the hydrogenation-catalyst treated polyethylene with a recycled polyethylene to make a thermoplastic composition,
wherein the recycled polyethylene comprises either a first blend of polyethylenes recovered from post-consumer material, a second blend of polyethylenes recovered from pre-consumer material, or a combination of the first and second blends; and
wherein the recycled polyethylene has:
a density of from 0.900 g/cm³ to 0.940 g/cm³ when measured according to ASTM D792-08, Method B;
a melt index (I₂) of from 0.30 dg/min to 6.00 dg/min when measured according to ASTM D1238-10, Method B, at 190° C. and a 2.16 kg load,
wherein the hydrogenation-catalyst treated polyethylene is from 80 wt % to 25 wt % of the thermoplastic composition based upon a total weight of the hydrogenation-catalyst treated polyethylene and the recycled polyethylene, and the recycled polyethylene is from 20 to 75 wt % of the thermoplastic composition based upon the total weight of the hydrogenation-catalyst treated polyethylene and the recycled polyethylene.

13. The method of claim 12, wherein the select processability parameters comprise complex viscosity at 100 rad/s (190° C.) and melt strength (190° C.), and wherein the thermoplastic composition has a complex r viscosity at 100 rad/s (190° C.) from 2500 to 3900 Pa*sand a melt strength (190° C.) from 7 to 15 cN.
